(19) United States
(12) Patent Application Publication
(10) Pub. No.: US 2007/0035755 A1
(43) Pub. Date: Feb. 15, 2007

(54) Composite image forming system

(75) Inventors: Yoichiro Maki, Nagano (JP); Hideyuki Narusawa, Nagano (JP)

Correspondence Address: EDWARDS & ANGELL, LLP, P.O. BOX 55874, BOSTON, MA, 02205, US

(73) Assignee: Seiko Epson Corporation, Tokyo (JP)

(21) Appl. No.: 11/504,191

(22) Filed: Aug. 14, 2006

(30) Foreign Application Priority Data
Aug. 12, 2005 (JP) 2005-234797

(51) Int. Cl. G06F 15/00

(52) U.S. Cl. 358/1.9

(57) ABSTRACT

A composite image forming system includes a color reduction unit, operable to form a background image which is a raster image by reducing a color gamut of a user image which is a raster image and is stored in a recording medium; an order form printing control unit, operable to cause a printing unit to print a figurative element which indicates a rectangular handwriting region whose long side is parallel to a long side of a paper, and an order form in which the background image is allocated to the handwriting region in a position in which a row or a column is parallel to the long side of the handwriting region; a scanning control unit, operable to cause a scanning unit to read an image in a region corresponding to the handwriting region from an order sheet on which a user has handwritten the figurative element in the handwriting region of the order form; a synthesizing unit, operable to form a composite image which is a raster image by using a color gamut of the background image to divide a handwritten element region corresponding to the figurative element handwritten by the user from the region corresponding to the handwriting region, and synthesizing the user image with an image in the handwritten element region; and a synthesizing printing control unit, operable to cause the printing unit to print the composite image allocated in a position in which the composite image is to be printed in the same direction as a direction in which the background image has been printed by the order form printing control unit.

### BACKGROUND OF THE INVENTION

The present invention relates to a composite image forming system.

A related composite image forming system includes a function of synthesizing a photographic image stored in a recording medium with a handwritten element and printing the composite image, has been known (for example, JP-A-2003-80789). Such a system includes: a function of reading a manuscript into which the handwritten element has been written; a region dividing function by which a handwritten element region is divided from the read manuscript; a synthesizing function by which a composite image is formed by synthesizing the photographic image stored in the recording medium with the handwritten image; and a printing function by which the composite image is printed. In such a system, it is preferable for a user to be able to write the handwritten element onto paper while adjusting a layout in a condition in which the user has recognized the relative positions of the handwritten element and the photographic image in the composite image. A related art enables the user to recognize the heretofore described relative positions by providing the user with a mounting which is used to faintly print the photographic image on the paper and enter the handwritten element thereon.

When printing an image which, being stored in the recording medium, has been encoded, for example, in a JPEG format, in the event that a memory for storing decode data for one image are not sufficient, a printing for the one image is actualized by repeating a process in which a corresponding image portion is decoded for each band to be printed, transferred to a memory, and printed. Although it is most efficient to decode and print the image in an order in which the encoded data are arranged, depending on a layout in which the image is allocated on the paper, the image has to be decoded and printed in a different order from the order of arrangement of the encoded data. However, when the layout of the image is set in favor of decode efficiency, in the event that it is required that the top and bottom of the image match those of the paper, in a case in which a composite image of the handwritten element and the photographic image is printed on, for example, a postcard, it will not be easy for the user to understand how to set the paper on a printing unit in order that the top and bottom of the image match those of the paper. Consequently, it is necessary to avoid a need to involve the user in such an operation as much as possible.

### SUMMARY

It is therefore an object of the invention to provide a composite image forming system which prints a mounting, which is used to write a handwritten element on a dimmed photographic image, and a composite image of the handwritten image and the photographic image, wherein paper can be easily set on a printing unit.

In order to achieve the object, according to the invention, there is provided a composite image forming system comprising:

a color reduction unit, operable to form a background image which is a raster image by reducing a color gamut of a user image which is a raster image and is stored in a recording medium;

an order form printing control unit, operable to cause a printing unit to print a figurative element which indicates a rectangular handwriting region whose long side is parallel to a long side of a paper, and an order form in which the background image is allocated to the handwriting region in a position in which a row or a column is parallel to the long side of the handwriting region;

a scanning control unit, operable to cause a scanning unit to read an image in a region corresponding to the handwriting region from an order sheet on which a user has handwritten the figurative element in the handwriting region of the order form;

a synthesizing unit, operable to form a composite image which is a raster image by using a color gamut of the background image to divide a handwritten element region corresponding to the figurative element handwritten by the user from the region corresponding to the handwriting region, and synthesizing the user image with an image in the handwritten element region; and

a synthesizing printing control unit, operable to cause the printing unit to print the composite image allocated in a position in which the composite image is to be printed in the same direction as a direction in which the background image has been printed by the order form printing control unit.

With this configuration, the composite image is printed in the same direction as the direction in which the image has been printed, so that it is easy for the user to understand in which direction to set paper whose top and bottom are determined, such as a postcard, on the printing unit.

The user image may include block-encoded data, the data being arranged in an order in which corresponding blocks may be arranged in raster order. The order form printing control unit may allocate the background image in a position in which the background image is printed from an upper side toward a lower side or from a left side toward a right side.

In this case, a limitation is imposed in such a way as to print in either of two kinds of pattern, from the upper side toward the lower side and from the left side to the right side, whereby it is possible to simplify the configuration of the order form printing control unit and the synthesizing printing control unit. As the user image is block-encoded and arranged in raster order, when the background image is allocated to the handwriting region in the position in which the background image is to be printed from the upper side toward the lower side, the blocks can be decoded and printed in the same order as the order in which they are arranged. Therefore, it is possible to execute a printing at a higher speed and more efficiently than in a case in which the background image is allocated in a position in which it is to be printed from the lower side toward the upper side.

The user image may include block-encoded data, the data being arranged in an order in which corresponding blocks may be arranged in raster order. The order form printing control unit may allocate the background image in a position in which the background image is printed from an upper side toward a lower side or from a right side toward a left side.

In this case, a limitation is imposed in such a way as to print in two kinds of patterns, from the upper side toward the lower side and from the right side to the left side, whereby it is possible to simplify the configuration of the order form printing control unit and the synthesizing printing Control unit. As the user image is block-encoded and arranged in raster order, when the background image is allocated to the handwriting region in the position in which the background image is to be printed from the upper side toward the lower side, the blocks can be decoded and printed in the same order as the order in which they are arranged. Therefore, it is possible to execute a printing at a higher speed and more efficiently than in the case in which the background image is allocated in the position in which it is to be printed from the lower side toward the upper side.

Each function of a plurality of units included in the invention is actualized by a hardware resource for which a function is specified by a configuration itself, a hardware resource for which a function is specified by a program, or a combination thereof. Also, each function of the plurality of units is not limited to one which is actualized by hardware resources which are physically independent of one another. Also, the invention can also be defined as any one of an invention of a program, an invention of a recording medium recording the program, or an invention of a method.

### BRIEF DESCRIPTION OF THE DRAWINGS

FIG. 1 is a schematic diagram according to an embodiment of the invention;

FIG. 2 is a block diagram according to the embodiment of the invention;

FIG. 3 is a schematic view according to the embodiment of the invention;

FIG. 4 is a plan view according to the embodiment of the invention;

FIG. 5 is a plan view according to the embodiment of the invention;

FIG. 6 is a flowchart according to the embodiment of the invention;

FIG. 7 is a plan view according to the embodiment of the invention;

FIGS. 8A and 8B are plan views according to the embodiment of the invention;

FIG. 9 is a plan view according to the embodiment of the invention;

FIG. 10 is a schematic view according to the embodiment of the invention;

FIG. 11 is a flowchart according to the embodiment of the invention;

FIGS. 12A to 12D are histograms according to the embodiment of the invention;

FIG. 13 is a flowchart according to the embodiment of the invention;

FIG. 14 is a plan view according to the embodiment of the invention;

FIG. 15 is a flowchart according to the embodiment of the invention;

FIG. 16 is a flowchart according to the embodiment of the invention;

FIG. 17 is a schematic view according to the embodiment of the invention;

FIG. 18 is a plan view according to the embodiment of the invention;

FIGS. 19A and 19B are schematic diagrams according to the embodiment of the invention;

FIG. 20 is a plan view according to the embodiment of the invention;

FIG. 21 is a graph according to the embodiment of the invention;

FIG. 22 is a flowchart according to the embodiment of the invention;

FIG. 23 is a schematic view according to the embodiment of the invention;

FIG. 24 is a graph according to the embodiment of the invention;

FIG. 25 is a schematic diagram according to the embodiment of the invention;

FIGS. 26A and 26B are schematic diagrams according to the embodiment of the invention;

FIGS. 27A to 27H are schematic diagrams according to the embodiment of the invention;

FIGS. 28A to 28H are schematic diagrams according to the embodiment of the invention; and

FIGS. 29A to 29D are schematic diagrams according to the embodiment of the invention.

### DETAIL DESCRIPTION OF PREFERRED EMBODIMENTS

A mode for carrying out the invention will hereafter be described based on an embodiment.

1. Configuration of Composite Image Forming System

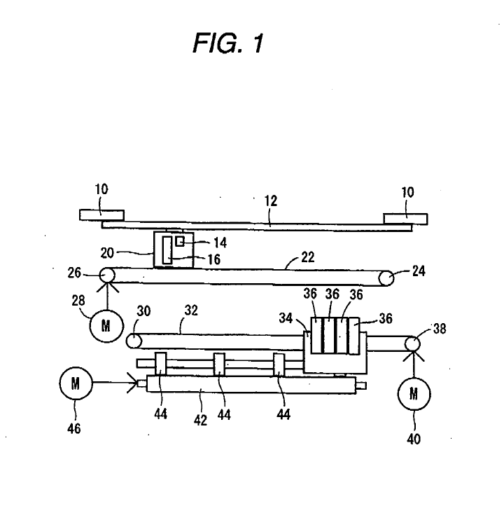

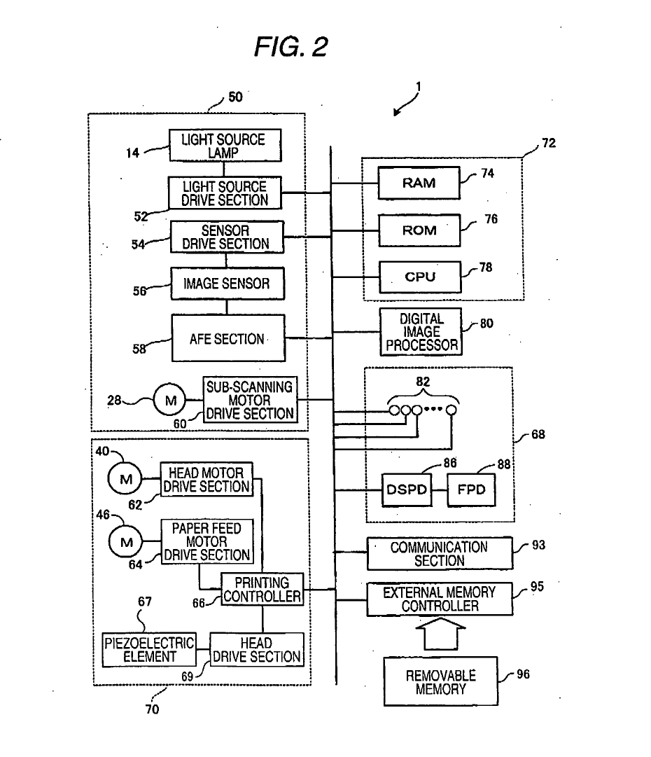

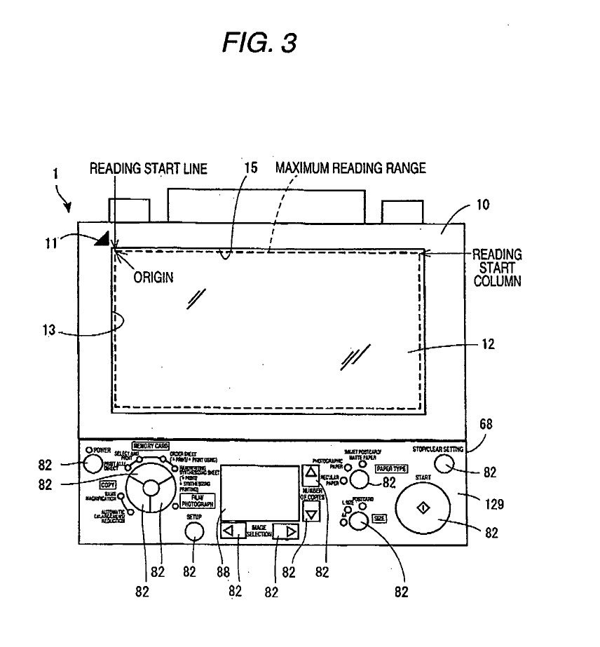

FIG. 1 is a schematic diagram showing a mechanical structure of a multifunction printer (MFP) 1 serving as an embodiment of a composite image forming system according to the invention. FIG. 2 is a block diagram showing an electrical configuration of the MFP 1. FIG. 3 is a plan view showing an external appearance of the MFP 1. The MFP 1 includes a function of receiving an image from a removable memory 96 and printing it, a function of reading and printing the image, and the like. The composite image forming system may also include a scanner which has an image reading function and a PC which has a function of controlling a printer having a printing function.

A scanning unit 50 includes a platen glass 12, a platen frame 10 holding the platen glass 12, a CIS (Contact Image Sensor) unit 16, a light source lamp 14, a carriage 20 mounting the CIS unit 16 and the light source lamp 14, a belt 22 engaged to the carriage 20, pulleys 24 and 26 wound with the belt 22, a sub-scanning motor 28 which rotates the pulleys 24 and 26, a light source drive section 52, a sensor drive section 54, a sub-scanning motor drive section 60, and the like.

The CIS unit 16 includes a not-shown refractive index profile lens and an image sensor 56. An image of a manuscript illuminated by the light source lamp 14 while being placed on the platen glass 12 is produced on a light receiving surface of the image sensor 56 through the refractive index profile lens. An optical system for producing the image of the manuscript on the image sensor 56 may also be a reduced optical system. The image sensor 56, in which a multiplicity of photodiodes is linearly arranged, is driven by the sensor drive section 54. The image sensor 56 transmits an analog signal correlated with the contrasting density of an optical image of the manuscript. The analog signal transmitted from the image sensor 56 is converted into a digital signal by an AFE (Analog Front End) section 58. The sub-scanning motor 28 is driven by the sub-scanning motor drive section 60 in such a way as to rotate the pulleys 24 and 26, thereby causing the carriage 20 to reciprocate in a direction (a sub-scanning direction) perpendicular to the direction of arrangement of the photodiodes of the image sensor 56 (a main scanning direction). The image sensor 56 moves in a direction perpendicular to the direction of arrangement of photoelectric conversion elements with respect to the manuscript, thereby reading an image from the manuscript in raster order. The sub-scanning method may also be a manuscript transporting method using an ADF (Auto Document Feeder).

A printing unit 70 includes a printhead 34 for printing the image on a sheet of paper using an inkjet method, a belt 32 engaged to the printhead 34, pulleys 30 and 38 around which the belt 32 is wound, a head motor 40 which rotates the pulleys 30 and 38, paper feed rollers 42 and 44, a paper feed motor 46 for rotating the paper feed rollers 42 and 44, a head motor drive section 62, a paper feed motor drive section 64, a head drive section 69, a printing control section 66, and the like. The printhead 34, including a piezoelectric element 67 which is driven by the head drive section 69, a nozzle and the like, ejects an ink, which is supplied from an ink cartridge 36, through the nozzle. The head motor 40 is driven by the head motor drive section 62 so as to rotate the pulleys 30 and 38, thereby causing the printhead 34 to reciprocate. The paper feed motor 46 is driven by the paper feed motor drive section 64 so as to rotate the paper feed rollers 42 and 44, thereby transporting the sheet of paper in a direction perpendicular to the direction of movement of the printhead 34. The printing control section 66 is an ASIC which includes a buffer memory to which ejection data is sequentially transmitted from an RAM 74, a function of controlling a timing of transmitting the ejection data stored in the buffer memory to the head drive section 69 in accordance with a position of the printhead 34, and a function of controlling the head motor drive section 62 and the paper feed motor drive section 64. The printing unit 70 may be of either laser method or of thermal method.

An external memory controller 95 is connected to the removable memory 96 inserted from a not-shown card slot. Data stored in the removable memory 96 is read by the external memory controller 95 and transferred to the RAM 74. The MFP1 may transmit a composite image formed by synthesizing a handwritten element with a user image, without printing it, to an external recording medium such as the removable memory 96.

A communication section 93 is a communication interface which is used for a controller 72 to communicate with an external system such as the PC. The communication section 93 communicates with the external system through a LAN, an internet, a USB or the like, and acquires data stored in a hard disk a compact disk or the like.

A digital image processor 80 is a DSP which executes an image processing, such as a gamma correction, a shading correction, a color balance correction, a JPEG image decode, a resolution conversion, an unsharp processing, a tone correction, a halftoning, and a separation processing, in cooperation with a CPU 78. The digital image processor 80 converts the format of the image transmitted from the scanning unit 50 and of the image read by the external memory controller 95 into a format suitable for a printing.

The controller 72 includes the RAM 74, an ROM 76 and the CPU 78. The CPU 78 controls each section of the MFP 1 by executing a control program stored in the ROM 76. The ROM 76 is a nonvolatile memory storing the control program. The RAM 74 is a nonvolatile memory which temporarily stores the control program and a variety of data such as the image read by the scanning unit 50. The control program may be stored in the ROM 76 via a network from a server at a remote location, and may also be stored in the ROM 76 via a computer-readable recording medium such as the removable memory 96.

An operating unit 68 includes an FPD (Flat Panel Display) 88 for displaying a menu and a status corresponding to a mode, a display drive section (DSPD) 86 which drives the FPD 88, a button group 82 which is used to change the mode, operate the menu and input a start request, and the like. A plurality of symbols with characters and figures for explaining LED's and buttons is printed on a housing 129. A screen of the FPD 88 is displayed by the DSPD 86 driving the FPD 88 based on an image which is generated by the controller 72 and stored in a frame memory region of the RAM 74.

A description has heretofore been given of a hardware configuration of the MFP 1.

2. Order Form Printing Process

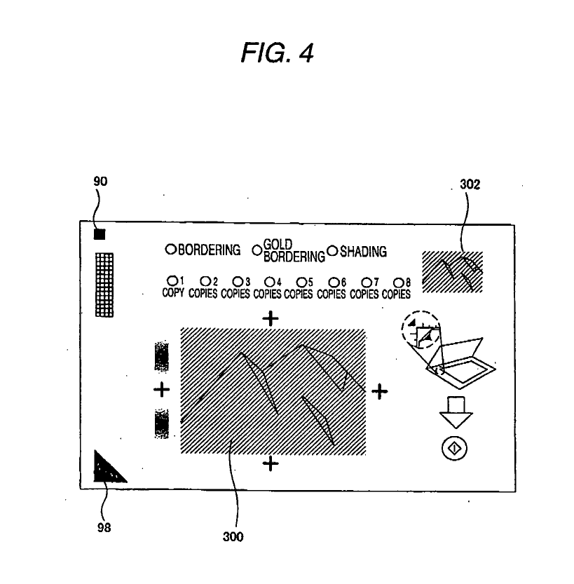

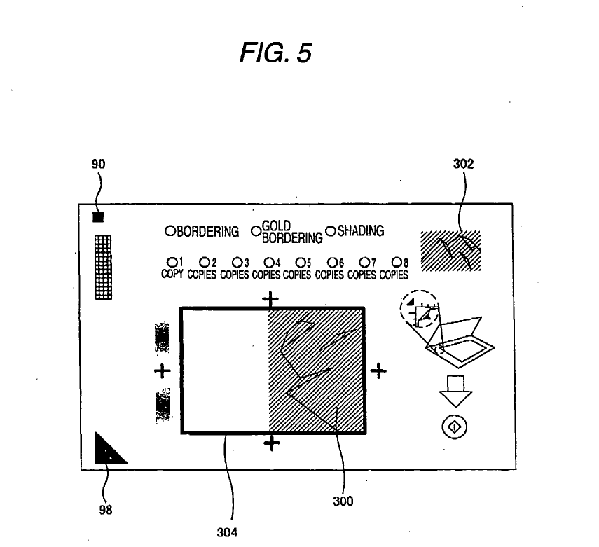

FIGS. 4 and 5 show an example of an order form printed by the printing unit 70. The order form is a mounting, into which a handwritten element is to be entered, having a composite image of an order form image, a background image 300 and an auxiliary image 302 printed on a standard-sized sheet of paper such as A4 size paper.

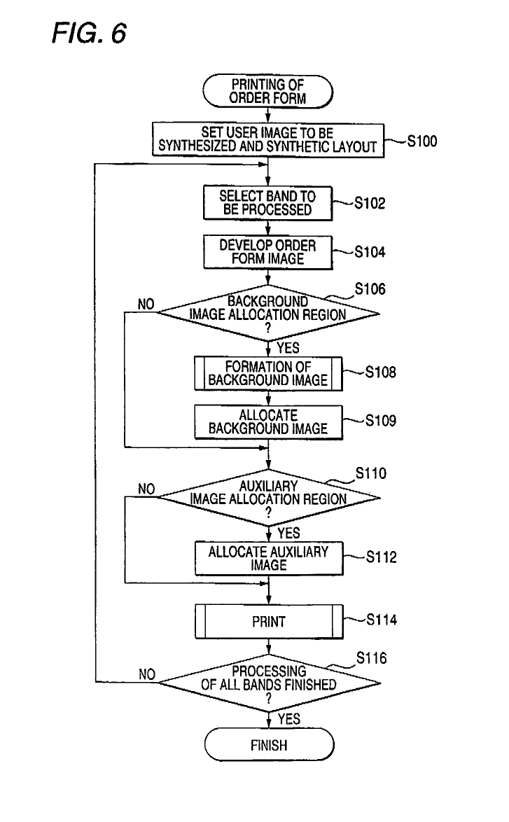

FIG. 6 is a flowchart showing a flow of an order form printing process. The process shown in FIG. 6 is started when a handwritten order sheet printing mode is selected by operating the button group 82, and is executed by the controller 72 executing a prescribed module of the control program stored in the ROM 76.

First, the controller 72 sets a user image to be synthesized and a synthetic layout (step S100). Specifically, for example, the controller 72 causes the FPD 88 to display the user image stored in the removable memory 96 and, when receiving a command to select a user image given by an operation of the button group 82, sets the user image corresponding to the selection command as an object to be synthesized. Also, for example, the controller 72 causes the FPD 88 to display the menu of synthetic layouts and, when receiving a command to select a synthetic layout by an operation of the button group 82, sets the synthetic layout corresponding to the selection command. An order form template and a synthetic template are set in accordance with the synthetic layout.

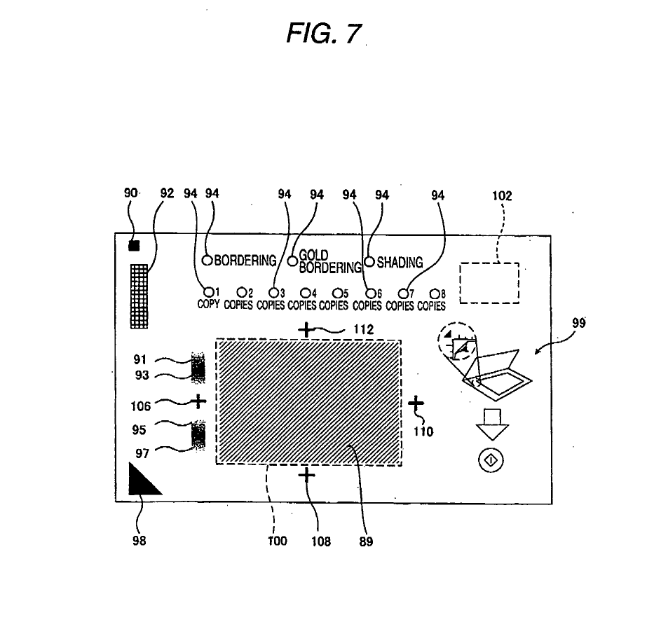

FIG. 7 shows an example of the order form image. The order form image, being an image of a JPEG format to be printed on, for example, an A4 size sheet of paper, is stored in the ROM 76 as order form template element data configured with layout control information of the order form image, the background image and the auxiliary image. The order form image can also be stored in the ROM 76 as a combination of commands to plot image parts.

A setting reference mark 98, as well as being a mark which indicates the left side of the order form corresponding to a reading start line of the scanning unit 50, is a reference mark which is used to calculate the position of an element on the order form based on the triangulation principle. The setting reference mark 98 is allocated to a corner at which the left and lower sides of the sheet of paper meet. (The left, right, top and bottom of the sheet of paper will be described with reference to the arrangement of characters included in the order form image.) As shown in FIG. 3, an origin mark 11 of a form corresponding to the setting reference mark 98 is formed on the platen frame 10. The origin mark 11 is a mark which indicates a point at which an edge 13 of the platen frame 10, which is provided along the reading start line, meets an edge 15 of the platen frame 10, which is provided along a reading start column. The reading start line and the reading start column, which correspond to the outer edge of a maximum reading range, are set in positions about 1 mm away respectively from the edges 13 and 15. A description of how to set the order form on the platen glass 12 using the setting reference mark 98 is supplemented with a setting guide diagram 99 shown in FIG. 7. A reference mark 90, being a reference mark which is used to calculate the position of an element on the order form based on the triangulation principle, is allocated to the upper left corner of the order form.

A block code 92 is a mark which causes the controller 72 to recognize an order form type. A plurality of request mark frames 94 are frames which indicate the entry positions of marks for causing the controller 72 to recognize synthesizing printing conditions, such as the number of copies to be printed and handwritten character and user image border processing conditions.

Sample patterns 91, 93, 95 and 97 are each a chart which conforms in color gamut to the background image and varies in density uniformly from white (transparency) to a maximum density of the background image. The sample patterns 91, 93, 95 and 97, lying closer to the setting reference mark 98 side than the handwriting region 100, are allocated to a region (a band region) which is elongated in a direction parallel to the left side of the sheet of paper. As the left side of the sheet of paper corresponds to the reading start line, the sample patterns 91, 93, 95 and 97 are read prior to the handwriting region 100. As the sample patterns 91, 93, 95 and 97 are allocated to a region which requires an area large enough to compensate variations in printing density, that is, a region which is elongated in a direction perpendicular to a reading line, they are read in a short time with respect to the area.

All sample colors in a predetermined background color gamut in which the background image is reduced in color are included in each of the sample patterns 91, 93, 95 and 97. Although the sample patterns 91, 93, 95 and 97 do not have to be a joint chart, preferably, all the sample colors in the background color gamut are included in each of a plurality of regions which do not overlap each other. Also, it is sufficient that a plurality of the sample colors in the background color gamut is included in each of the sample patterns 91, 93, 95 and 97, and it is also acceptable that not all the colors in the background color gamut are necessarily included therein. A color, which is not read in the background color gamut as a sample color, can be interpolated by a color obtained by reading another plurality of sample colors.

The handwriting region 100 is designed in such a way that its long side is parallel to the long side of the order form.

The background image is allocated to a rectangular background image region 89, the coordinates of opposite vertexes of which are recorded in the ROM 76. As shown in FIG. 4, the handwriting region 100 may be caused to conform to the background image 89 and, as shown in FIG. 5, the background image region may also be set in a part of the handwriting region 100. In the case of allocating the background image to a part of the handwriting region 100, preferably, a frame 304 clearly indicating the outer edge of the handwriting region 100 is printed with a color in the color gamut of the background image around the handwriting region 100.

An auxiliary image region 102 has the coordinates of its opposite vertexes recorded in the ROM 62, and the user image is allocated to the auxiliary image region 102 with its tone characteristics intact. The user image allocated to the auxiliary image region 102 is a main image of high resolution, but may also be a thumbnail image of low resolution.

Cross marks 106, 108, 110 and 112 serving as region detection reference marks are marks for causing the controller 72 to recognize a region, in which the sample patterns 91, 93, 95 and 97 are arranged, and the handwriting region 100. The cross marks 106, 110, 108 and 112 are each allocated onto a perpendicular bisector of each side of the handwriting region 100. The cross marks 106, 108, 110 and 112 are allocated to positions closer to the handwriting region 100 than the setting reference mark 98 and the reference mark 90. Consequently, it becomes possible to more exactly recognize the handwriting region 100 and the regions of the sample patterns 91, 93, 95 and 97 by referring to the cross marks 106, 108, 110 and 112 than by the triangulation using the setting reference mark 98 and the reference mark 90 as reference points.

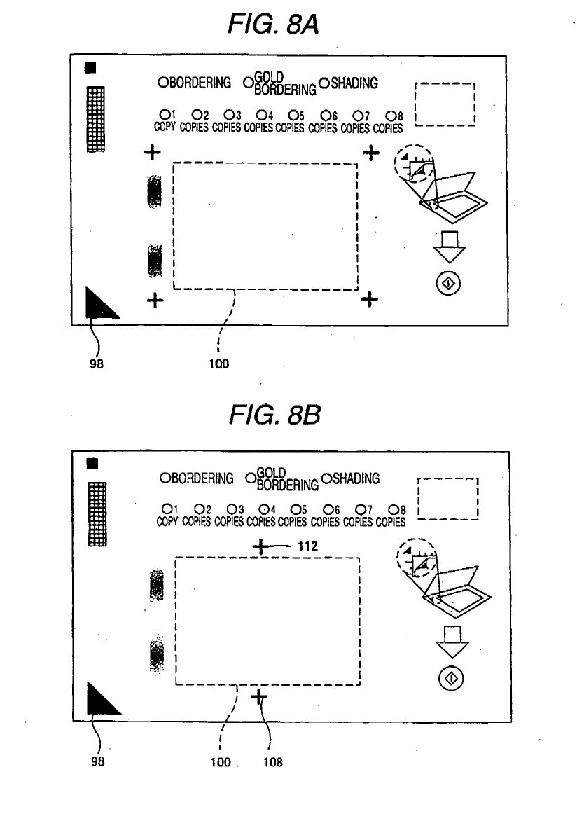

As shown in FIG. 8A, the cross marks may also be four points which are disposed near the vertexes of the rectangular handwriting region 100. Also, as shown in FIG. 8B, the region detection reference marks may include the setting reference mark 98 and two cross marks 108 and 112.

A description has heretofore been given of the order form template.

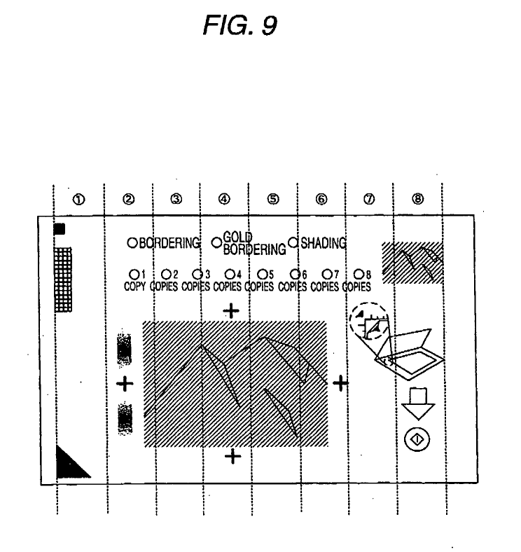

In step S102, the controller 72 selects a band to be processed. Specifically, the controller 72, while referring to the order form template, divides the order form into, for example, eight bands as shown in FIG. 9, and executes the following order form printing process for each band in the direction of 1 to 8 sequentially from the side on which the setting reference mark 98 is disposed.

In step S104, the controller 72 transfers the order form image to the RAM 74.

In step S106, the controller 72 determines whether or not a background image allocation region is included in the band to be processed. If the background image allocation region is included in the band to be processed, a user image region included in the band to be processed is read from the removable memory 96 into the RAM 74 and decoded into an RGB format.

In step S108, the controller 72 forms the background image from the user image in cooperation with the digital image processor 80.

The user image which provides a source of the background image may be an image of the highest resolution which is synthesized with an object such as a handwritten character, and may also be a thumbnail image. By forming the background image based on the thumbnail image, it is possible to shorten a processing time.

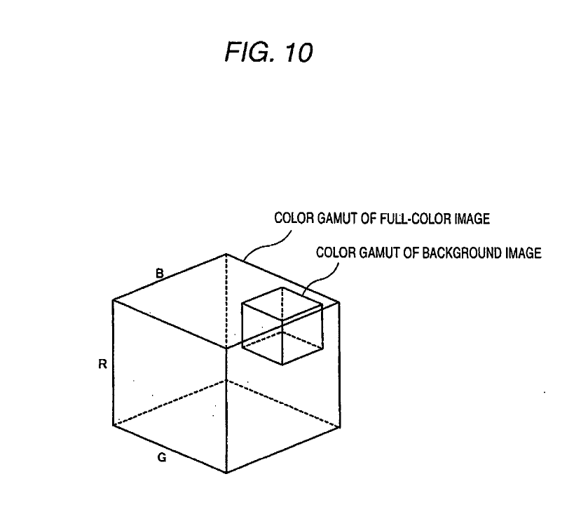

FIG. 10 is a schematic view showing the color gamut of a full-color user image and the color gamut of the background image (a background color gamut). When a tone value of each channel has 1 byte, the color gamut of the full-color user image has a color value of 16777216 (256×256×256). In a case in which the color gamut of the user image spreads all over a color space, it is very difficult to optically recognize the region of a handwritten element such as a character written on top of the printed user image with a color pen or the like. In a case in which the color gamut of the user image does not overlap the color gamut in the region of the handwritten element, pixels in a specific color gamut can be determined to be in the character region. In order to widen the range of the color gamut of a handwritten element, such as a character, which can be written on top of the user image, that is, in order to increase the number of colors which can be used by a user, it is necessary to narrow the color gamut (background color gamut) of the user image printed underneath the handwritten element.

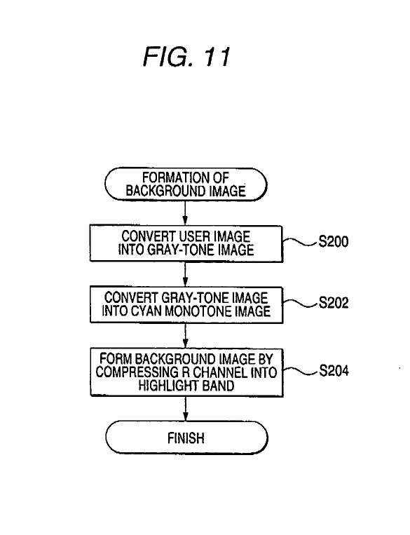

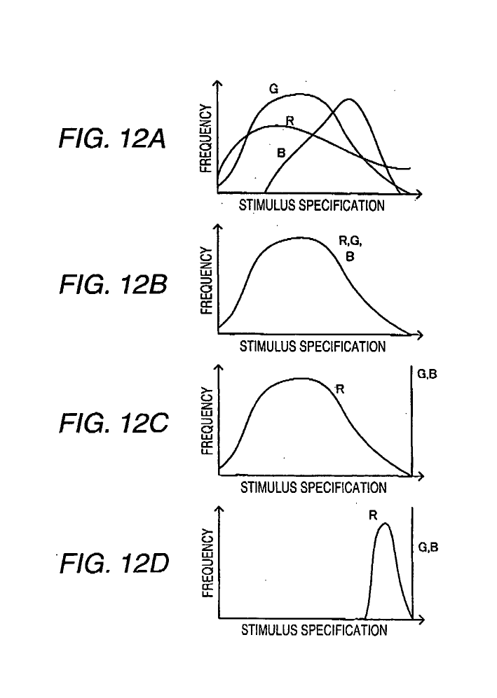

FIG. 11 is a flowchart showing a flow of a process of forming the background image from the user image. FIGS. 12A to 12D are diagrams showing a change in tone characteristics in the process before the background image is generated from the user image.

First, the controller 72 converts the user image into a gray-tone image (step S200). When the user image having the tone characteristics shown in FIG. 12A is converted into the gray-tone image, in the tone characteristics of the gray-tone image, the histograms of R, G and B channels come to conform to each other as shown in FIG. 12B. The controller 72 may generate the gray-tone image by obtaining lightness from R, G and B and converting the tone values of R, G and B into values having a linear relation with the lightness, and may also generate the gray-tone image by converting the tone values of the R and B channels into the tone value of the G channel.

Next, the controller 72 converts the gray-tone image into a cyan monotone image (step S202). Specifically, for example, the controller 72, while leaving only the tone value of the R channel, which is complementary cyan, as it is, sets each of the tone values of the G and B channels to one fixed value (for example, 255/255). The hue of the monotone image is not particularly limited to cyan, and can be any single hue, but is preferably of an ink color of the printing unit 70 such as cyan, magenta or yellow. When the gray-tone image having the tone characteristics shown in FIG. 12B is converted into the cyan monotone image by converting all the tone values of the G and B channels into maximum values, the monotone image comes to have the tone characteristics shown in FIG. 12C.

Next, the controller 72 forms the background image by compressing the tone value of the cyan monotone image into a highlight band (step S204). The resulting formed background image, as it has the tone value of the R channel concentrated in the highlight band, becomes a fainter image than the original user image. Specifically, for example, the controller 72 converts the tone value of the R channel in such a way that the shadow level of the R channel of the cyan monotone image rises to a prescribed value (for example, 200/255). The background image formed by compressing the tone value of the R channel of the monotone image shown in FIG. 12C into the highlight band comes to have the tone characteristics shown in FIG. 12D. A description has heretofore been given of the background image forming process.

In step S109, the controller 72 allocates the background image to the background image region 89 corresponding to the selected synthetic layout.

In step S110, the controller 72 determines whether or not an auxiliary image allocation region is included in the band to be processed.

If the auxiliary image allocation region is included in the band to be processed, the controller 72 reads a user image region included in the band to be processed from the removable memory 96 into the RAM 74, and allocates it to the auxiliary image region (step S112). Specifically, the controller 72 converts the resolution of the user image read into the RAM 74 in accordance with the size of the auxiliary image region 102, and allocates the user image to the auxiliary image region 102 with its tone characteristics left as they are.

In step S114, the controller 72 controls the printing unit 70 and causes it to execute a printing of the order form.

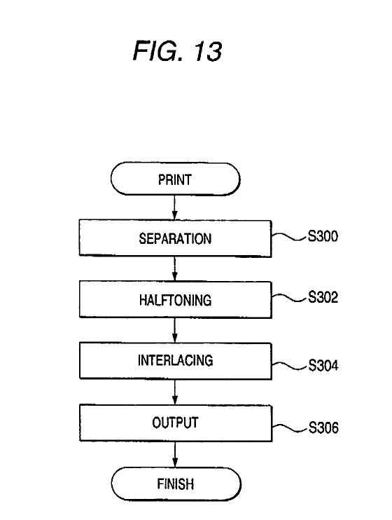

FIG. 13 is a flowchart showing a flow of an order form printing process.

In step S300, the controller 72 executes a separation process. Specifically, for example, the controller 72 converts the tone value of the band to be processed from a value of an RGB color space to a value of a CMY color space (and may also cause it to have an auxiliary channel of K (black) or the like). As a result, in principle, the background image, which is the cyan monotone image in which the G and B channels each have the fixed value and only the R channel has a tone, and the sample patterns 91, 93, 95 and 97 come to have the tone characteristics in which only the C (cyan) channel has a tone. However, in practice, due to a discrepancy in a grid value of a 3D-LUT used for a conversion from the RGB value to the CMY value, and a discrepancy in an interpolation process between 3D-LUT grids, generally, a tone having a narrow width in highlight band appears even in M and Y channels of the background image 300 and the sample patterns 91, 93, 95 and 97.

In step S302, the controller 72 executes a halftoning. The halftoning is basically a process of converting an array of multiple tone color values into a binary array as to determining whether or not to eject ink droplets. In a case of selectively using a large, medium and small ink droplet, the multiple tone color values are converted into one of four values, ejection of no ink droplets, ejection of the small ink droplet, ejection of the medium ink droplet, and ejection of the large ink droplet, on a channel to channel basis. In this case, as there are four tones which can be expressed in ink droplets, a discrepancy occurs in the tone of each pixel. By dispersing the discrepancy on neighboring pixels, it is possible to pseudo-wise express a large number of tones.

After the halftoning, the controller 72 executes an interlacing in which the four-valued ejection data formed by the halftoning is rearranged in ejection order (step S304).

In step S306, the controller 72 transmits the ejection data to the printing controller 66 in ejection order, and the printing controller 66 drives the printhead 34 based on the ejection data which are sequentially stored in the buffer memory.

In step S116, the controller 72 determines whether or not the processing of all the bands is finished. The controller 72 executes the process from step S102 to step S114 sequentially for all the bands, and finishes the order form printing process.

3. Entry into Order Form

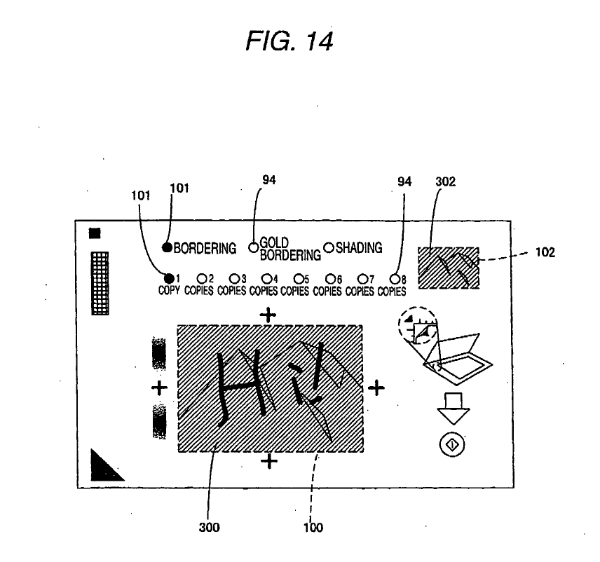

FIG. 14 is a plan view showing an example of an order sheet having characters “Hi!” entered, as the handwritten element, on the order form printed in the process described heretofore. In the example shown in FIG. 14, as the background image is printed in the whole handwriting region 100, the outer edge of the handwriting region 100 is clearly indicated by the outer edge of the background image 300. An object to be synthesized with the user image by attaching thereto a clipping from a magazine, a sticker or the like may be recorded in the handwriting region 100. Also, the user can set desired printing conditions by blacking out an arbitrary request mark frame 94.

As the relative positions of the background image 300 and the handwriting region 100 conform to the relative positions in a composite image of the user image, which is a source of the background image 300, and an image obtained by reading the handwriting region 100, the user can enter the handwritten element into the handwriting region 100 while recognizing a space configuration of the user image based on a space configuration of the faintly printed background image 100. That is, the user can enter the handwritten element into the handwriting region 100 while recognizing to which region of the user image to allocate the handwritten element. Also, as the auxiliary image 302 is printed in the auxiliary image region 102 using the same tone characteristics as those of the user image, the user can reliably recognize the relative positions of the user image and the handwritten element based on the background image 300 printed in the handwriting region 100 and the auxiliary image printed in the auxiliary image region 102.

Also, as the background image 300 has only the single hue (cyan), the user can enter the handwritten element into the handwriting region 100 using any hue other then cyan. Also, as the background image 300 is dimmed, the user can enter the handwritten element into the handwriting region 100 using any color which, even though it is of the same hue as that of the background image 300, is of different lightness and saturation from those of the background image 300. That is, it means that the MFP 1 can optically recognize the region of the handwritten element entered into the handwriting region 100 using any different hue from that of the background image 300, and that the MFP 1 can optically recognize the region of any handwritten element so long as it has been recorded using any color which, even though it is of the same hue as that of the background image 300, is of different lightness and saturation from those of the background image 300.

It is sufficient that the background image 300 is any one in which the color gamut of the user image is reduced, and the background image 300 does not always have to be of a single hue. So long as the maximum color gamut of the background image 300 is predetermined, it is sufficient to lead the user to use a writing material of any color outside the color gamut of the background image 300. Also, the background image 300 does not always have to be of multiple tones, but may also include a drawing of a single color which represents an edge component of the user image.

4. Synthesizing of User Image and Handwritten Element

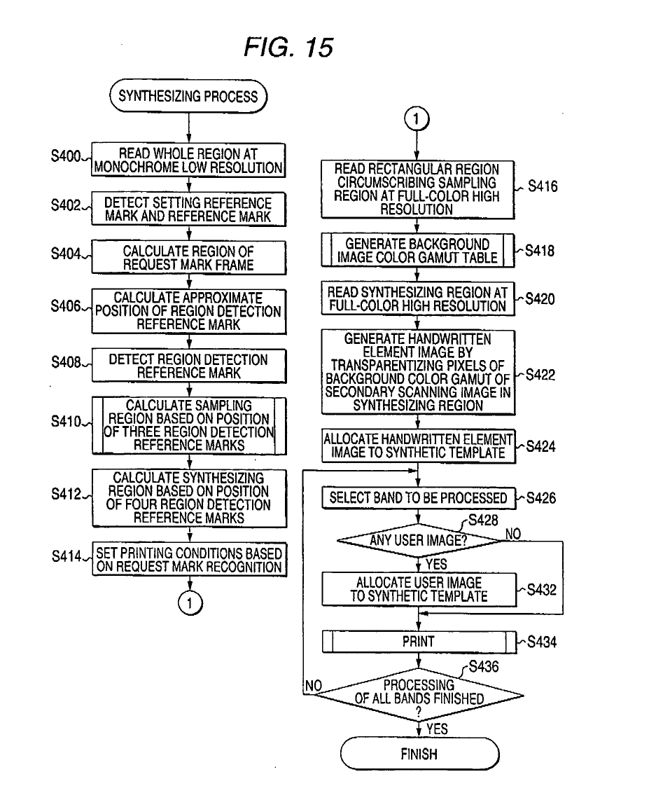

FIG. 15 is a flowchart showing a flow of a process in which the MFP 1 reads the order sheet and prints a composite obtained by synthesizing the handwritten element entered into the order sheet with the user image. The process shown in FIG. 15 is started when a start request of a mode, in which a handwritten composite image is printed using the order sheet, is input to the MFP 1 by an operation of the button group 82 with the order sheet set on the platen glass 12 of the MFP 1.

In step S400, the scanning unit 50 reads the order sheet at a monochrome low resolution. Specifically, by the scanning unit 50 reading a maximum reading region (a first scanning region) at the monochrome low resolution, an image of the order sheet set on the platen glass 12 is read, and the read order sheet image is stored in the RAM 74. The controller 72 binarizes the read order sheet image at a prescribed threshold (for example, 128/255).

In step S402, the controller 72 analyzes the binarized order sheet image, and detects the position of the setting reference mark 98 and the reference mark 90. Specifically, for example, in a case in which the order sheet is properly set on the platen glass 12, a region which is slightly larger than the region from which the setting reference mark 98 and the reference mark 90 are read, is subjected to an edge detection process and a pattern matching, thereby detecting the position of the lower left corner of the setting reference mark 98, the upper left corner of the reference mark 90, and the like.

In step S404, the controller 72 calculates the region of each request mark frame 94 with reference to the positions of the setting reference mark 98 and the reference mark 90. Specifically, for example, the controller 72 corrects a preset reading region of each request mark frame 94 based on the read positions of the setting reference mark 98 and the reference mark 90.

In step S406, the controller 72 calculates regions from which the cross marks 106, 108, 110 and 112 are likely to have been read, based on the positions of the setting reference mark 98 and the reference mark 90. Specifically, for example, the controller 72 corrects preset regions from which the cross marks 106, 108, 110 and 112 are likely to have been read, based on the read positions of the setting reference mark 98 and the reference mark 90.

In step S408, the controller 72 analyzes the order sheet image in the regions from which the cross marks 106, 108, 110 and 112 are likely to have been read, and detects the positions of the cross marks 106, 108, 110 and 112. Specifically, for example, the controller 72 subjects each region calculated in step S406 to the edge detection process and the pattern matching, and detects the center positions of the cross marks 106, 108, 110 and 112.

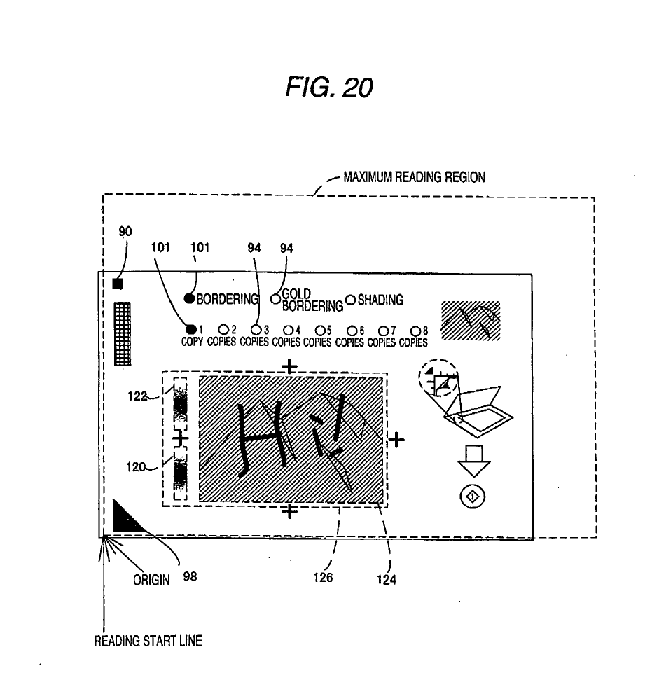

In step S410, the controller 72 calculates sampling regions 120 and 122 (refer to FIG. 20) based on the positions of three cross marks 106, 108 and 112.

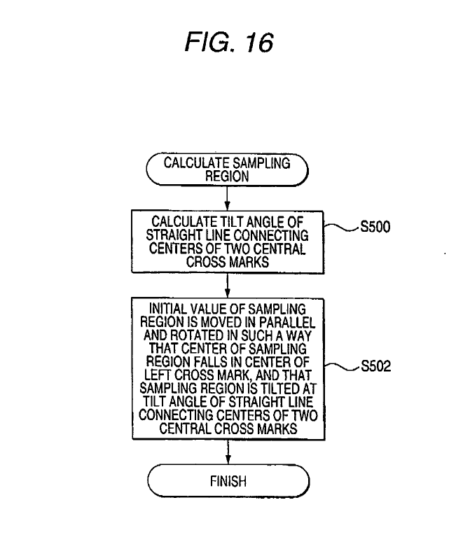

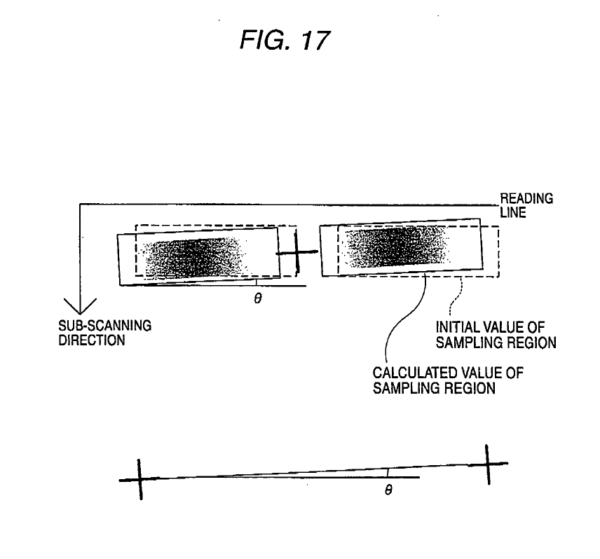

FIG. 16 is a flowchart showing a flow of a sampling region calculation process. FIG. 17 is a schematic view for illustrating the sampling region calculation process.

In step S500, the controller 72 calculates a tilt angle θ of a straight line connecting the centers of two central cross marks 108 and 112.

In step S502, the controller 72 converts an initial value of each sampling region in such a way that the center between two sampling regions falls in the center of the left cross mark 106, and that the sampling regions tilt at the tilt angle θ of the straight line connecting the centers of the two central cross marks 108 and 112. The conversion employs, for example, an alfin conversion, in which the regions are moved in parallel and rotated. The initial values of the sampling regions are set to a rectangular reading region corresponding to the allocation region of the sample patterns 91 and 93, and a rectangular reading region corresponding to the allocation region of the sample patterns 95 and 97. That is, the sampling regions are set in such a way as to avoid a reading region corresponding to the allocation region of the left cross mark 106. A position vector is indicated by coordinates representing an arbitrary point, on the surface of the platen glass 12, which has its origin at a point at which the reading start line meets the reading start column.

In step S412, the controller 72 calculates a synthesizing region 124 (refer to FIG. 20) corresponding to the handwriting region 100 using detected position vectors of the four cross marks 106, 108, 110 and 112 and predetermined coefficients.

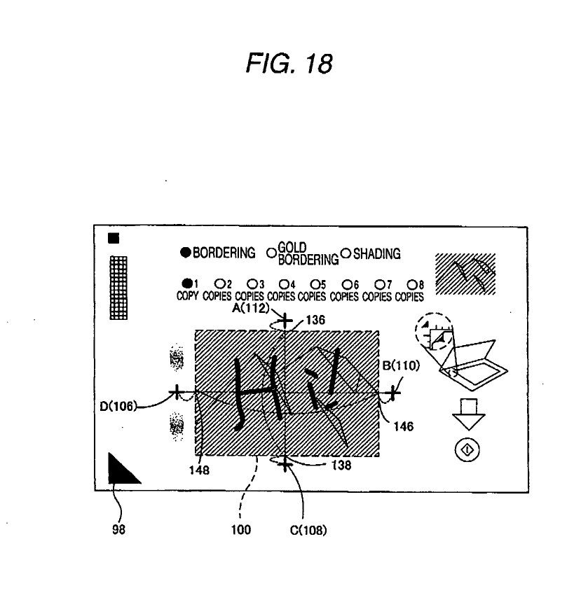

FIG. 18 is a schematic view for illustrating a synthesizing region calculation process.

Specifically, for example, when detected center positions of the cross marks 112, 110, 108 and 106 are indicated by points A, B, C and D respectively, the controller 72 calculates the position (vector A×0.9+vector C×0.1) of a point 136 which internally divides a line segment AC into 1:9, and the position (vector A×0.1+vector C×0.9) of a point 138 which internally divides the line segment AC into 9:1. Next, the controller 72 calculates the position (vector B×0.9+vector D×0.1) of a point 146 which internally divides a line segment BD into 1:9, and the position (vector B×0.1+vector D×0.9) of a point 148 which internally divides the line segment BD into 9:1. The region ranging from the column of the point 138 to the column of the point 136 and from the row of the point 148 to the row of the point 146 is set as the synthesizing region. In an image (portrait) read from the order sheet with the left side of the order sheet corresponding to the reading start line, a vertical array of pixels is defined as a column, and a horizontal array of pixels is defined as a row. When the synthesizing region is set in this way, one side of the synthesizing region is always parallel to the reading line, meaning that, in the event that the order sheet is set aslant on the platen glass 12, an accurate region corresponding to the handwriting region 100 is not set as the synthesizing region. However, as there are multiple factors causing a region corresponding to the handwriting region 100 of the image read from the order sheet to tilt with respect to the reading line (for example, the reading line is not perpendicular to the reading column), even though a synthesizing region tilting with respect to the reading line is set with reference to the four cross marks 106, 108, 110 and 112, there is no guarantee that it is possible to set a synthesizing region corresponding accurately to the handwriting region 100. Needless to say, of the factors causing the region corresponding to the handwriting region 100 to tilt with respect to the reading line, which factor is to be considered or ignored is a design matter, so that a region surrounded by a straight line, which is parallel to the line segment BD and passes through the point 136, a straight line, which is parallel to the line segment BD and passes through the point 138, a straight line, which is parallel to the line segment AC and passes through the point 146, and a straight line, which is parallel to the line segment AC and passes through the point 148, may also be set as the synthesizing region.

In any case, even in the event that, due to a magnification error during a printing, an expansion and contraction of paper due to a temperature or the like, a magnification error during a scanner reading, and the like, a region from which the handwriting region 100 should have been read in accordance with a design handwriting region 100 is displaced with respect to a region from which the handwriting region 100 has actually been read, such factors which cause the displacement cause a uniform displacement in a certain direction. Therefore, by calculating the synthesizing region using the position vector of each cross mark and the predetermined coefficients, the synthesizing region, which is calculated as the region from which the handwriting region 100 has actually been read, can be calculated with high accuracy. Consequently, the handwritten element which the user has written into the handwriting region 100 can be synthesized with the user image in an accurate positioning relationship which the user has intended.

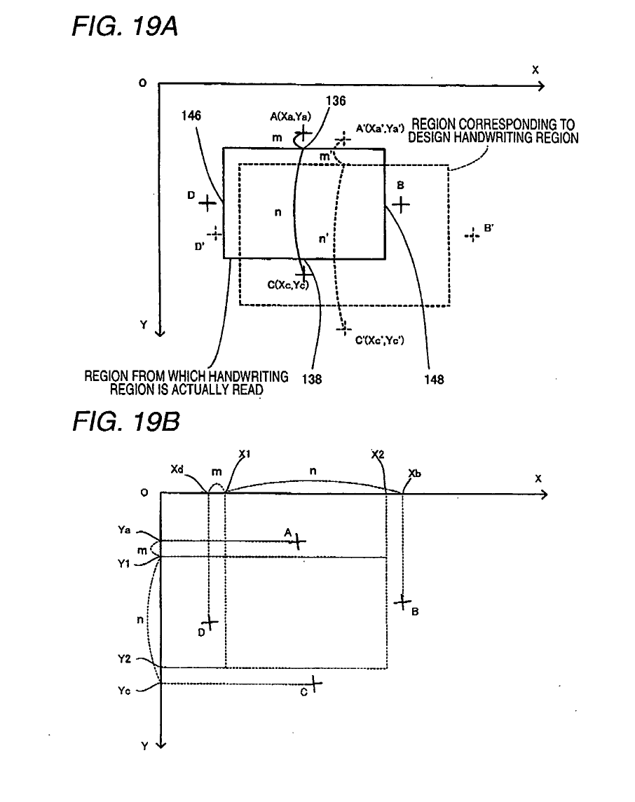

A more specific description will be given based on FIGS. 19A and 19B. As shown in FIG. 19A, in the case in which the region from which the handwriting region 100 should have been read in accordance with the design handwriting region 100 is displaced with respect to the region from which the handwriting region 100 has actually been read, an absolute distance between each cross mark and the handwriting region in the former region is different from that in the latter region (m≠m′, n≠n′). However, it can be said that the internal division ratio of a line segment, in the former region, which, connecting the opposite cross marks, has an internal division point at a point at which the line segment connecting the opposite cross marks meets the outer edge of the handwriting region, is constant with respect to that in the latter region (m:n=m′:n′). Therefore, the synthesizing region can be calculated with high accuracy using the detected position vector of each cross mark and the coefficients. As for the coefficients, coefficients corresponding to the Internal division ratios may be stored in the ROM 76, and it is also acceptable to configure in such a way that the coordinates of the design cross marks and the coordinates of four points at which the line segments connecting the opposite cross marks meet the outer edge of the handwriting region are stored in the ROM 76, and that the coefficients corresponding to the internal division ratios are obtained from those coordinates. Even in the case of obtaining the coefficients corresponding to the internal division ratios from the coordinates stored in the ROM 76, as the coordinates from which the internal division ratios are obtained are predetermined, it can naturally be said that the internal division ratios are also predetermined.

As shown in FIG. 19B, the synthesizing region may also be calculated by one-side components of the coordinates of the opposite cross marks and the predetermined coefficients. Specifically, Xb−Xd is calculated from X components (Xb and Xd) of the point B and the point D, and then multiplied by the predetermined coefficients corresponding to the internal division ratio of the line segment which, connecting the cross marks, has an internal division point at a point at which the line segment connecting the cross marks meets the outer edge of the handwriting region, thereby calculating X1 and X2. Also, Xa−Xc is calculated from X components (Xa and Xc) of the point A and the point B, and then multiplied by the predetermined coefficients corresponding to the internal division ratio of the line segment connecting the cross marks, thereby calculating Y1 and Y2. A region with thus calculated (X1, Y1), (X2, Y1), (X1, Y2) and (X2, Y2) as its vertexes may also be set as the synthesizing region. In this way, even in the case of setting the synthesizing region using only one-side components of the position vector of each cross mark and the coefficients, the calculation of the X components and the calculation of the Y components are carried out, meaning that the synthesizing region is set using at least three position vectors and the predetermined coefficients. Thus, unless the tilt of the region corresponding to the handwriting region 100 is corrected, eventually, it is possible to obtain the same advantageous effect as that of the vector calculation described heretofore.

In step S414, the controller 72 analyzes the region of each request mark frame 94, which has been calculated in step S404, and sets printing conditions corresponding to blacked out request marks 101 (refer to FIG. 20).

In step S416, the scanning unit 50 reads a rectangular region including two sampling regions 120 and 122 (refer to FIG. 20) at a full-color high resolution. Specifically, for example, an elongated rectangular region whose long side is parallel to the reading line is read at the full-color high resolution. Images of the two read sampling regions 120 and 122 are stored in the RAM 74.

In step S418, the controller 72 generates a table representing the background color gamut (a background color gamut table) based on the images of the sampling regions 120 and 122. The background color gamut table is a lookup table in which is stored a color gamut of pixels obtained by reading the sample patterns 91, 93, 95 and 97 which conform to the color gamut of the background image.

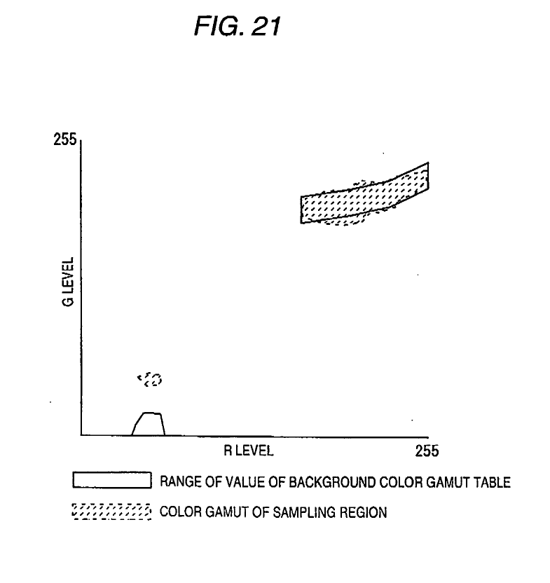

FIG. 21 is a graph showing an example of a color gamut represented by the background color gamut table. In order to accurately divide the region obtained by reading the background image from the synthesizing region 124, the controller 72 has to store the color gamut of the pixels read from the sample patterns 91, 93, 95 and 97 which conform to the color gamut of the background image. Therefore, a modeling becomes necessary for storing the color gamut of the pixels read from the sample patterns 91, 93, 95 and 97 in a limited capacity of the RAM 74. As the sample patterns 91, 93, 95 and 97 and the background image are printed as images of a single hue of cyan, in the image obtained by reading the sample patterns 91, 93, 95 and 97, theoretically, only the R channel will have a tone, and the B and G channels will have the tone characteristics of a fixed value (for example, 255/255). However, actually, due to separation accuracy, a difference in device color between the scanning unit 50 is and the printing unit 70, and the like, a tone also appears in the B and G channels of the image obtained by reading the sample patterns 91, 93, 95 and 97. However, the B and G channel tones are strongly correlated with the R channel tone, and have the characteristic of varying only within a narrow width. Therefore, the controller 72, by storing a distribution method of the B and G channel tones with respect to the R channel tone, can store the color gamut of the pixels read from the sample patterns 91, 93, 95 and 97, which conform to the color gamut of the background image, in a small capacity. Specifically, for example, the controller 72, by examining three R, G and B channel values of the images in the sampling regions 120 and 122 on a pixel to pixel basis and calculating the range of distribution of the G and B channels with respect to an arbitrary R channel value having as a median the mean value of each of the G and B channels with respect to the arbitrary R channel value, can store the color gamut of the pixels read from the sample patterns 91 93, 95 and 97. A detailed description will hereafter be given based on a flowchart.

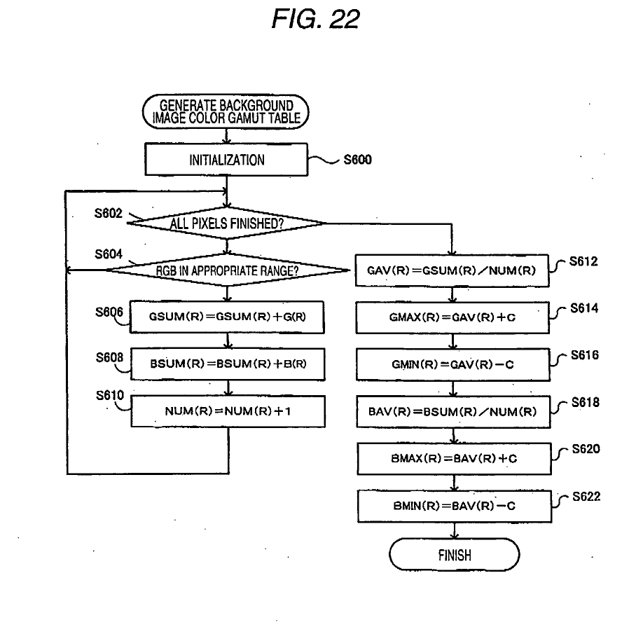

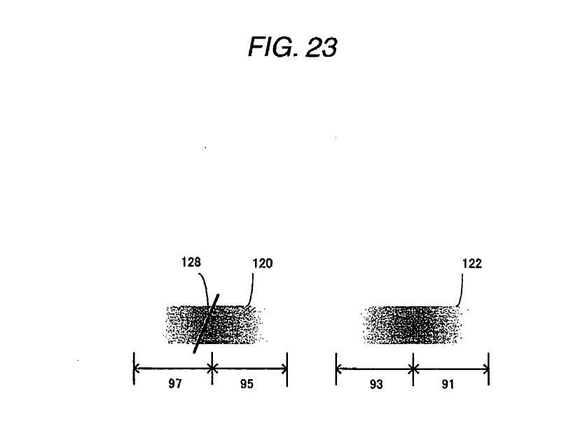

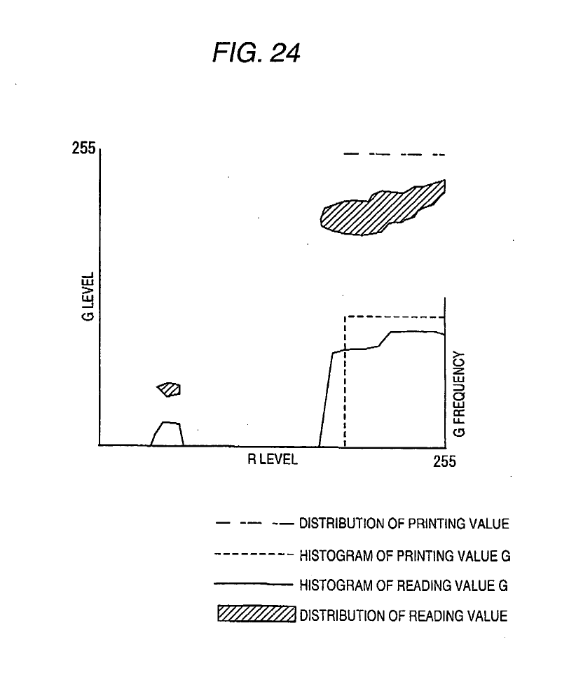

FIG. 22 is a flowchart showing a flow of a background color gamut table generating process. FIG. 23 is a schematic view showing an example of the sampling regions 120 and 122 of an image read from the order sheet in a case in which the handwritten element is entered on the sample patterns 95 and 97. FIG. 24 is a graph showing a distribution of a B level with respect to an arbitrary R level of pixels forming the sampling regions 120 and 122 in a case in which the handwritten element is entered on the sample patterns 95 and 97, that is, of the pixels read from the sample patterns 91, 93, 95 and 97.

First, the controller 72, after resetting a frequency NUM (R), a total G level GSUM (R), a total B level BSUM (R), a G level average GAV(R), a B level average GAV(R), a G maximum level GMAX(R), a G minimum level GMIN(R), a B maximum level BMAX(R), and a B minimum level BMIN(R) for all the R levels (step S600), repeats the following process with respect to all the pixels read from the sampling regions 120 and 122 at the full-color high resolution (step S602).

In step S604, the controller 72 determines whether or not each of the R, G and B levels is a level in an appropriate range. Specifically, for example, the controller 72 determines that each of the R, G and B levels, if it is higher than a preset level, is the level in the appropriate range. As a result, pixels read from a dark color handwriting, which exists on the printed sample patterns 91, 93, 95 and 97, are ignored. However, such a determination is effective only when the order form is printed on a sheet of paper verging on white. In the event that the order form is printed on a dark gray sheet of paper, all the pixels will be ignored, and it becomes impossible to generate the background color gamut table. In order to respond even to such a case, it is preferable to preset the background color gamut table for use in an abnormal time.

By statistically obtaining the appropriate range of each of R, G and B, it is possible to generate a more accurate background color gamut table. A specific principle is as follows. A histogram of the G and B levels of all the pixels is generated with respect to each R level (refer to FIG. 24). The histogram represents how the G level of all the pixels having a level of, for example, R=200/255 is distributed in a range of 0/255 to 255/255. A frequency for each interval of the histogram is obtained, and pixels corresponding to a low-frequency interval are ignored. In the sample patterns 91, 93, 95 and 97, as a total area of regions of uniform color is somewhat wide, even though a user's handwriting exists locally on the sample patterns 91, 93, 95 and 97, the number of pixels read from the handwriting is likely to be considerably smaller than the number of pixels read from the region of the sample patterns 91, 93, 95 and 97 of a color blacked out by the handwriting. Consequently, by ignoring pixels corresponding to the low-frequency interval, even though the handwriting has a color verging on that of the sample patterns 91, 93, 95 and 97, it is possible to ignore the pixels read from the handwriting. However, in the event that the sample patterns 91, 93, 95 and 97 are widely blacked out with a considerably different color from that of the sample patterns 91, 93, 95 and 97, conversely, the pixels read from the sample patterns 91, 93, 95 and 97 will be ignored. Even in this case, it is possible to previously ignore pixels of considerably dark color with a color, considerably remote from a printing color of the sample patterns 91, 93, 95 and 97, used as a threshold and, after that, obtain an appropriate range using a statistic technique.

In step S606, the controller 72 updates the total G level. Specifically, the controller 72 adds the G level of the pixels of interest to a total G level corresponding to the R level of the pixels of interest.

In step S608, the controller 72 similarly updates the total B level.

In step S610, the controller 72 updates the frequency of the R level of the pixels of interest. Specifically, the controller 72 adds 1 to a frequency corresponding to the R level of the pixels of interest.

When the above process is finished with respect to all the pixels in the sampling regions 120 and 122, the controller 72 calculates a value of the background color gamut table in the following manner.

In step S612, for all the R levels, the controller 72 calculates the G level average GAV(R) by dividing the total G level by the frequency of the R level.

In steps S614 and S616, for all the R levels, the controller 72 calculates the G level distribution range having the G level average as the median. Specifically, the controller 72 sets a level, obtained by adding a prescribed value C to the G level average, as the G maximum level GMAX(R), and sets a level, obtained by subtracting the prescribed value C from the G level average, as the G minimum level GMIN(R).

In steps S618 and S620, for all the R levels, the controller 72 similarly calculates the B level distribution range having the B level average BAV(R) as the median.

Although the calculation of the G and B level distribution ranges using such mean values is a process of compensating ink droplet ejection variations of the printing unit 70, it is not necessarily a required process. In place of such a process, for example, the maximum and minimum levels of each of the G and B levels corresponding to all the R levels of pixels remaining after pixels outside the appropriate range are removed can also be calculated as the G and B level distribution ranges.

When the above process is finished with respect to all the R levels, for all the R levels, the maximum and minimum values of the B and G levels are stored in the background color gamut table, and the color gamut of the sample patterns 91, 93, 95 and 97 is stored. The data size of the table in which the maximum and minimum values of the B and G levels are stored related to the R levels is only 1 K byte (256×2×2 bytes) in a case in which the tone value of each channel is 1 byte. A description has heretofore been given of the background color gamut table generating process.

In step S420 (refer to FIG. 15), the scanning unit 50 reads the image in the synthesizing region 124 at the full-color high resolution. The image in the synthesizing region 124 is stored in the RAM 74. The image in a region 126 (a secondary scanning region) including the synthesizing region 124 and the sampling regions 120 and 122 may also be read by one pass under the same reading conditions.

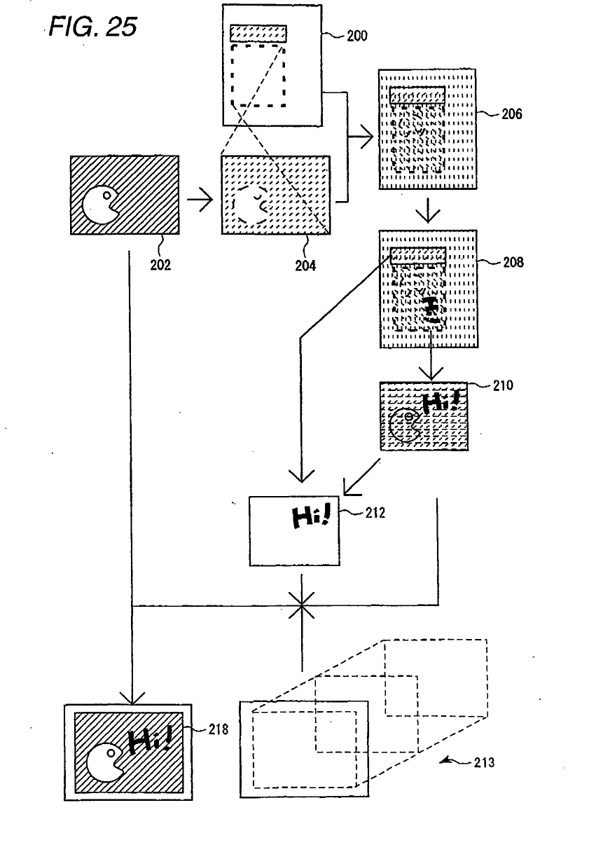

FIG. 25 is a schematic diagram showing an image group which is generated in a series of steps before a composite image is formed from a user image 202. Reference numeral 204 depicts a background image formed from the user image 202 by a color reduction process. Reference numeral 200 depicts an order form image. Reference numeral 206 depicts an order form resulting from printing an image, obtained by synthesizing the order form image 200 with the background image 204, on a sheet of paper. Vertical broken lines represent a ground color of the sheet of paper. Reference numeral 208 depicts an order sheet in which the handwritten element is entered. Reference numeral 210 depicts an image read from the synthesizing region 124.

In step S422, the controller 72 generates an α channel 212 on which pixels in the background gamut of the image 210 read from the synthesizing region 124 become transparent (in FIG. 25, the α channel 212 is shown with pixels of a transparent value expressed in white and pixels of a nontransparent value expressed in black). Specifically, the controller 72 determines whether or not the B and G levels of the pixels of interest fall within the range of the B and G levels which are stored in the background color gamut table, being related to the R level of the pixels of interest, recognizes the pixels of interest within the range as the image read from the background image, and sets the level of the α channel thereof to be transparent, while it recognizes the region of the pixels of interest outside the range as the pixels read from the handwritten element, and sets the level of the α channel thereof to be nontransparent As a result, the handwritten element images of the R, G and B channels of the image 210 obtained by reading the synthesizing region 124, and of four R, G, B and α channels having the a channel 212 are generated.

In step S424, the controller 72 allocates the handwritten element images to the synthetic template 213.

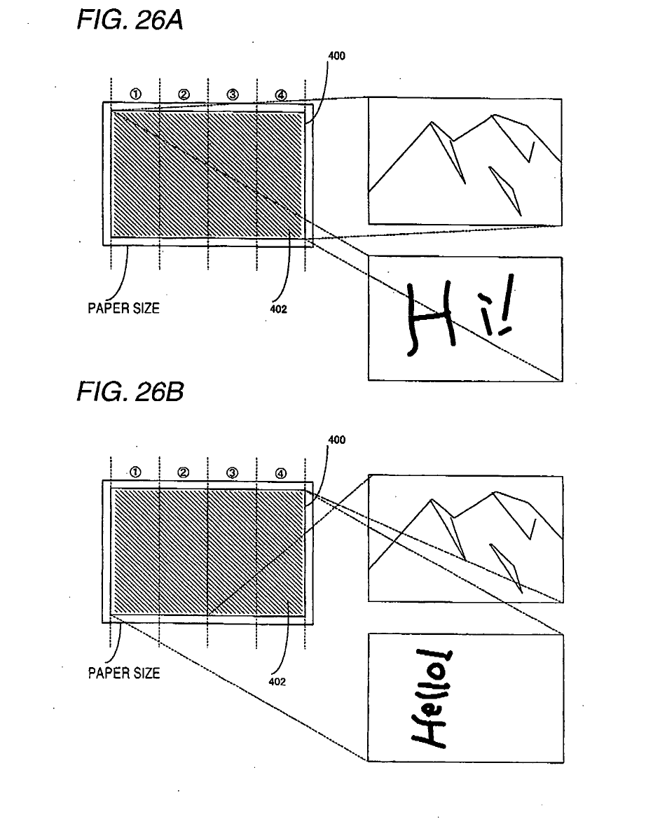

In step S426, the controller 72 selects a band to be processed. Specifically, for example, the controller 72 divides a page into, for example, four bands as shown in FIGS. 26A and 26B, and executes a process of synthesizing and printing the handwritten element with the user image in the order of 1 to 4, on a band to band basis in the following manner.

In step S428, the controller 72 determines whether or not the user image allocation region is included in the band to be processed.

If a lower region 400 to which the user image is allocated is included in the band to be processed, the controller 72 reads the user image included in the band to be processed from the removable memory 96 into the RAM 74, decodes the user image into the RGB format, and allocates the user image to the lower region 400 (step S432). Specifically, for example, the controller 72 allocates the user image to the synthetic template as shown in FIGS. 26A and 26B. The synthetic template, being a template which is used to synthesize the user image with the handwritten character etc, and print the composite image on, for example, postcard size paper, is stored in the ROM 76 as layout control information of the lower region 400, to which the user image is allocated, and an upper region 402, to which the synthesizing region is allocated. The relative positions of the lower region 400 and the upper region 402 are the same as the relative positions of the background image region 86 and the handwriting region 100 in the order form template. FIG. 26A corresponds to the synthetic layout of the order form template shown in FIG. 4, while FIG. 26B corresponds to the synthetic layout of the order form template shown in FIG. 5.

In step S434, the controller 72 controls the printing unit 70 in such a way as to execute a printing of the composite image.

In step S436, the controller 72 determines whether or not the processing of all the bands has been finished. The controller 72 sequentially executes the process from step S426 to step S434 for all the bands, and forms the composite image on the sheet of paper.

When the series of steps described heretofore is finished, the MFP 1 generates a print obtained by synthesizing the handwritten character etc. entered into the order form with the user image which has been generated by a digital camera or the like and stored in the removable memory 96.

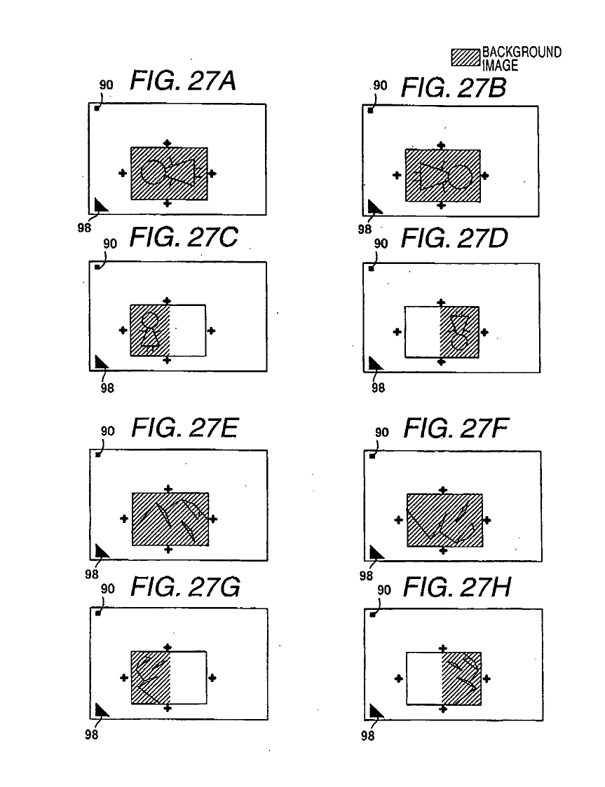

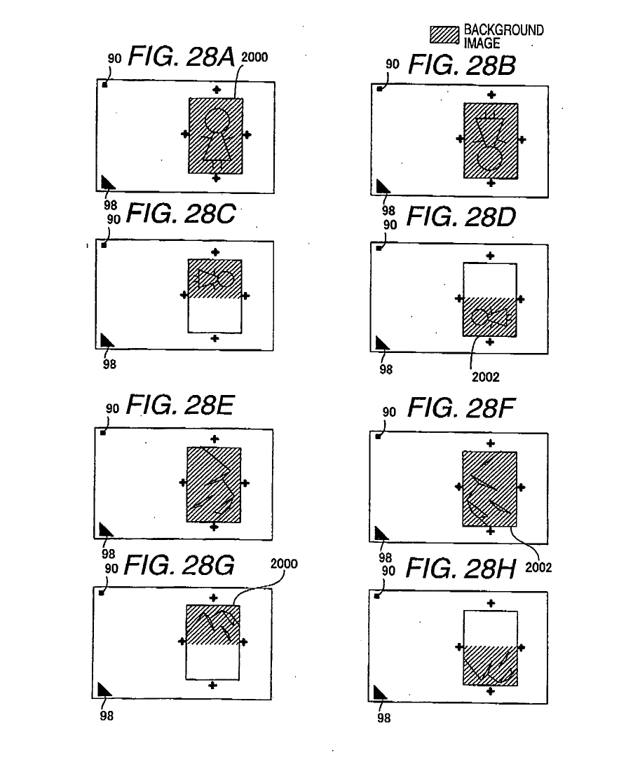

Meanwhile, as the layout of the order form, a layout, in which the long side of the handwriting region 100 is parallel to the long side of the sheet of paper as shown in FIGS. 27A to 27H, and a layout, in which the short side of the handwriting region 100 is parallel to the short side of the sheet of paper as shown in FIGS. 28A to 28H, can be considered. In the embodiment described heretofore, in providing a synthetic layout, in which the user image is allocated to the whole image of the handwriting region 100, and a synthetic layout, in which the user image is allocated to half the image of the handwriting region 100, the layout in which the long side of the handwriting region 100 is parallel to the long side of the sheet of paper is employed for the reason to be described hereafter.

Generally, a printer can transport a sheet of paper with higher accuracy, that is, without causing the sheet of paper to pass obliquely, when transporting the sheet of paper in such a way that the long side of the sheet of paper is parallel to the paper transporting direction of the printing unit 70 as compared with transporting the sheet of paper in such a way that the long side of the sheet of paper is perpendicular to the paper transporting direction of the printing unit 70.

As already described, an order form printing and a composite image printing are processed on a band to band basis. In the event that the background image and composite image allocation regions are included in the band to be processed, the controller 72 reads the user image region included in the allocation regions from the removable memory 96 to the RAM 74, and carries out processes such as decoding, background image generation, synthesizing, printing and the like.

First, a description will be given of a case in which the user image is portrait.

In the layout shown in FIG. 28A, during the order form printing, as the background image is printed from the left side toward the right side, the portrait user image is processed from the left side toward the right side, while, during the synthesizing printing, as the composite image is printed from the upper side toward the lower side, the portrait user image is processed from the upper side toward the right side. In the layout shown in FIG. 28C, during the order form printing, as the background image is printed from the lower side toward the upper side, the user image is also processed from the lower side toward the upper side, while, during the synthesizing printing, as the composite image is printed from the left side toward the right side, the user image is also processed from the left side toward the right side. In this way, in a combination of the layouts in FIGS. 28A and 28C, the user image is processed in different directions in the order form printing and the synthesizing printing, and the processing direction has three patterns, from the left side to the right side, from the upper side to the lower side, and from the lower side to the upper side. In the case in which the user image is portrait, whether in the combination of the layouts in FIGS. 28A and 28D, in the combination of the layouts in FIGS. 28B and 28C, or in the combination of the layouts in FIGS. 28B and 28D, the user image is processed in different directions in the order form printing and the synthesizing printing, and the processing direction has three of the patterns, from the left side to the right side, from the right side to the left side, from the upper side to the lower side, and from the lower side to the upper side.

Next, a description will be given of a case in which the user image is landscape.

In the layout shown in FIG. 28F, during the order form printing, as the background image is printed from the upper side toward the lower side, the landscape user image is processed from the upper side toward the lower side, while, during the synthesizing printing, as the composite image is printed from the right side toward the left side, the landscape user image is processed from the right side toward the left side. In the layout shown in FIG. 28G, during the order form printing, as the background image is printed from the left side toward the right side, the user image is also processed from the left side toward the right side, while, during the synthesizing printing, as the composite image is printed from the upper side toward the lower side, the user image is also processed from the upper side toward the lower side. In this way, in a combination of the layouts in FIGS. 28F and 28G, the user image is processed in different directions in the order form printing and the synthesizing printing, and the processing direction has three patterns, from the upper side to the lower side, from the right side to the left side, and from the left side to the right side. In the case in which the user image is landscape, whether in the combination of the layouts in FIGS. 28E and 28G, in the combination of the layouts in FIGS. 28E and 28H, or in the combination of the layouts in FIGS. 28F and 28H, the user image is processed in different directions in the order form printing and the synthesizing printing, and the processing direction has three of the patterns, from the left side to the right side, from the right side to the left side, from the upper side to the lower side, and from the lower side to the upper side.

In order to limit the process order, although it is also possible to cause the user to set the sheet of paper in such a way that the paper transporting direction varies according to the layout, it is preferable that the printing unit 70 transports the sheet of paper in such a way that the transporting direction is parallel to the long side of the sheet of paper as already described, but when the orientation (position) of a sheet of paper to be set varies according to the layout, it is likely to result in a confusion in the mind of the user. Specifically, for example, when intending to limit an image printing direction to two patterns, from the upper side to the lower side and from the left side to the right side, preferably, the sheet of paper is set on the printing unit 70 in such a way that the long side of the sheet of paper is parallel to the transporting direction, meaning that, when carrying out the synthesizing printing in such a layout as FIG. 28A or FIG. 28G, the printing is started from a side 2000 side, and that, when carrying out the synthesizing printing in such a layout as FIG. 28D or FIG. 28F, the printing is started from a side 2002 side. Therefore, in a case such as the one of printing the composite image on a sheet of paper whose top and bottom are determined like a postcard, it becomes difficult for the user to understand in which direction to set the postcard on the printing unit 70.

However, in the layouts in which the long side of the handwriting region 100 is parallel to the long side of the sheet of paper as shown in FIGS. 27A to 27H, as the user image can be processed from the same direction both during the order form printing and during the synthesizing printing, it is easier for the user to understand intuitively than in the layouts shown in FIGS. 28A to 28H. A specific description will be given hereafter.

First, a description will be given of a case in which the user image is portrait.

In the layout shown in FIG. 27A, during the order form printing, as the background image is printed from the upper side toward the lower side, the portrait user image is also processed from the upper side toward the lower side, and, during the synthesizing printing as well, as the composite image is printed from the upper side toward the lower side, the portrait user image is also processed from the upper side toward the lower side. In the layout shown in FIG. 27C, during the order form printing, as the background image is printed from the left side toward the right side, the user image is also processed from the left side toward the right side, and, during the synthesizing printing as well, as the composite image is printed from the left side toward the right side, the user image is also processed from the left side toward the right side. In this way, in a combination of the layouts in FIGS. 27A and 27C, the user image is processed in the same direction in the order form printing and the synthesizing printing, and the processing direction has two patterns, from the upper side to the lower side and from the left side to the right side. In the case in which the user image is portrait, whether in the combination of the layouts in FIGS. 27A and 27D, in the combination of the layouts in FIGS. 27B and 27C, or in the combination of the layouts in FIGS. 27B and 27D, the user image is processed in the same direction in the order form printing and the synthesizing printing, and the processing direction has two patterns, either from the left side to the right side or from the right side to the left side, and either from the upper side to the lower side or from the lower side to the upper side.

Next, a description will be given of a case in which the user image is landscape.

In the layout shown in FIG. 27E, during the order form printing, as the background image is printed from the left side toward the right side, the landscape user image is also processed from the left side toward the right side, and, during the synthesizing printing as well, as the composite image is printed from the left side toward the right side, the landscape user image is also processed from the left side toward the right side. In the layout shown in FIG. 27G, during the order form printing, as the background image is printed from the upper side toward the lower side, the user image is also processed from the upper side toward the lower side, and, during the synthesizing printing as well, as the composite image Is printed from the upper side toward the lower side, the user image is also processed from the upper side toward the lower side. In the case in which the user image is landscape, whether in the combination of the layouts in FIGS. 27F and 27G or in the combination of the layouts in FIGS. 27F and 28H, the user image is processed in the same direction in the order form printing and the synthesizing printing, and the processing direction has two patterns, either from the left side to the right side or from the right side to the left side, and either from the upper side to the lower side or from the lower side to the upper side.

Consequently, in the layouts shown in FIGS. 27A to 27H, it is possible to reduce the number of printing direction patterns as compared with in the layouts shown in FIGS. 28A to 28H.

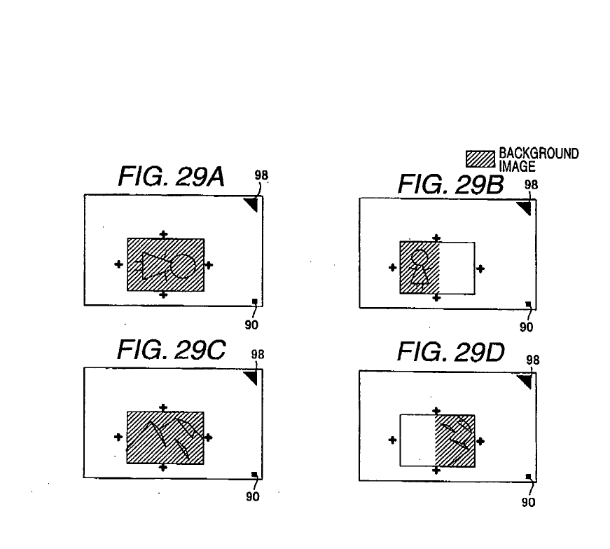

Meanwhile, the user image is encoded in the JPEG format and stored in the removable memory 96. Image data of the JPEG format is configured in such a way that raster images, which are arranged from the left side toward the right side in a horizontal direction, and from the upper side to the lower side in one screen, are encoded with 8×8 pixels as one block, and that the encoded blocks are arranged sequentially from the left toward the right in the horizontal direction, and from the top toward the bottom in one screen. It is most efficient that the blocks of the user image are read from the removable memory 96 into the RAM 74, decoded and printed in the order in which the encoded blocks are arranged, that is, in the order of the upper left to the lower right. Consequently, the layouts in FIGS. 27A and 27G are the most efficient in that the image is printed from the upper side toward the lower side both during the order form printing and during the composite image printing. Combinations of the layouts including FIGS. 27A and 27G for providing a synthetic layout, in which the user image is allocated to the whole image of the handwriting region 100, and a synthetic layout, in which the user image is allocated to half the image of the handwriting region 100, are FIGS. 27A and 27C, FIGS. 27A and 27D, FIGS. 27E and 27G, and FIGS. 27F and 27G. Of them, the combinations with which the user does not feel uncomfortable when writing the handwritten character into the handwriting region 100 of the order form (the user does not have to rotate the orientation of the order form through an angle of 180 degrees) are FIGS. 27A and 27C and FIGS. 27E and 27G. These combinations, corresponding to a combination in which the background image and the composite image are printed from the upper side toward the lower side or from the right side toward the left side, can be efficiently printed and are easy for the user to understand. Also, an order form such as the one shown in FIGS. 29A to 29D is acceptable in which the background image is allocated to the handwriting region in such a way that the background image and the composite image are printed from the upper side toward the lower side or from the right side toward the left side.

What is claimed is:

1. A composite image forming system comprising:
a color reduction unit, operable to form a background image which is a raster image by reducing a color gamut of a user image which is a raster image and is stored in a recording medium;
an order form printing control unit, operable to cause a printing unit to print a figurative element which indicates a rectangular handwriting region whose long side is parallel to a long side of a paper, and an order form in which the background image is allocated to the handwriting region in a position in which a row or a column is parallel to the long side of the handwriting region;
a scanning control unit, operable to cause a scanning unit to read an image in a region corresponding to the handwriting region from an order sheet on which a user has handwritten the figurative element in the handwriting region of the order form;
a synthesizing unit, operable to form a composite image which is a raster image by using a color gamut of the background image to divide a handwritten element region corresponding to the figurative element handwritten by the user from the region corresponding to the handwriting region, and synthesizing the user image with an image in the handwritten element region; and
a synthesizing printing control unit, operable to cause the printing unit to print the composite image allocated in a position in which the composite image is to be printed in the same direction as a direction in which the background image has been printed by the order form printing control unit.

2. The composite image forming system according to claim 1, wherein
the user image includes blockencoded data, the data being arranged in an order in which corresponding blocks are arranged in raster order, and
the order form printing control unit allocates the background image in a position in which the background image is printed from an upper side toward a lower side or from a left side toward a right side.

3. The composite image forming system according to claim 1, wherein
the user image includes block-encoded data, the data being arranged in an order in which corresponding blocks are arranged in raster order, and
the order form printing control unit allocates the background image in a position in which the background image is printed from an upper side toward a lower side or from a right side toward a left side.
